(19) United States
(12) Patent Application Publication
(10) Pub. No.: US 2013/0198063 A1
(43) Pub. Date: Aug. 1, 2013

(54) SYSTEM AND METHOD TO FACILITATE FUND TRANSFER BETWEEN ONLINE POKER GAMING SITES

(71) Applicant: Michael Murray, Monona, WI (US)

(72) Inventor: Michael Murray, Monona, WI (US)

(21) Appl. No.: 13/756,179

(22) Filed: Jan. 31, 2013

Related U.S. Application Data
(60) Provisional application No. 61/592,752, filed on Jan. 31, 2012.

(51) Int. Cl. G06Q 20/10

(52) U.S. Cl. CPC G06Q 20/10
USPC 705/39

(57) ABSTRACT

A system and method to facilitate the transfer of monetary balances from a first predetermined location where a user holds a personal account to a second predetermined location, unrelated to the first predetermined location, where a user holds a separate personal account.

### CROSS-REFERENCE TO RELATED APPLICATION

This application claims the benefit of U.S. Application Ser. No. 61/592,752, titled SYSTEM AND METHOD TO FACILITATE FUND TRANSFER BETWEEN ONLINE POKER GAMING SITES, filed Jan. 31, 2012, which is hereby incorporated by reference in its entirety.

### BACKGROUND OF THE INVENTION

In the current online poker gaming market, withdrawals and deposits are not instant. For example, if a user has some amount of money in their account on one site and a larger amount on another, they may want to reload the first smaller account using funds from the second larger account. In this example, the user would have to withdraw funds from one site, wait for the check, deposit the funds on the other site, and wait for the transaction to go through.

Further, laws relating to online gaming and to money transfer vary by country and jurisdiction. As part of the above gaming-related funds transfer, the system could be designed to alert the user of the national laws related to the geographic location from the which the user is making a transfer and/or impose restrictions on transfer based on the user's geographic location.

### SUMMARY OF THE INVENTION

The present invention (the “website”) relates to a website that allows a user to quickly and easily transfer monetary balances between the user's separate personal accounts on unrelated poker websites. In short, the invention relates to a website that transfers balances from one online poker gaming site to another poker gaming site to allow a user to more freely access capital.

The operator of the present invention would maintain accounts at predetermined online poker gaming sites. A user of the present invention has the ability to quickly transfer money between their accounts on these same predetermined online poker gaming sites by using the accounts held by the operator of the present invention as a “middle-man,” by way of first transferring funds from the user's account on one site into the operator's account on that same site, and then receiving a transfer of funds from the operator's account on a second gaming site into the user's account on the same second gaming site.

### BRIEF DESCRIPTION OF THE DRAWINGS

FIG. 1 is an example of a login page that allows a user to begin use of the disclosed website in one embodiment of the present invention.

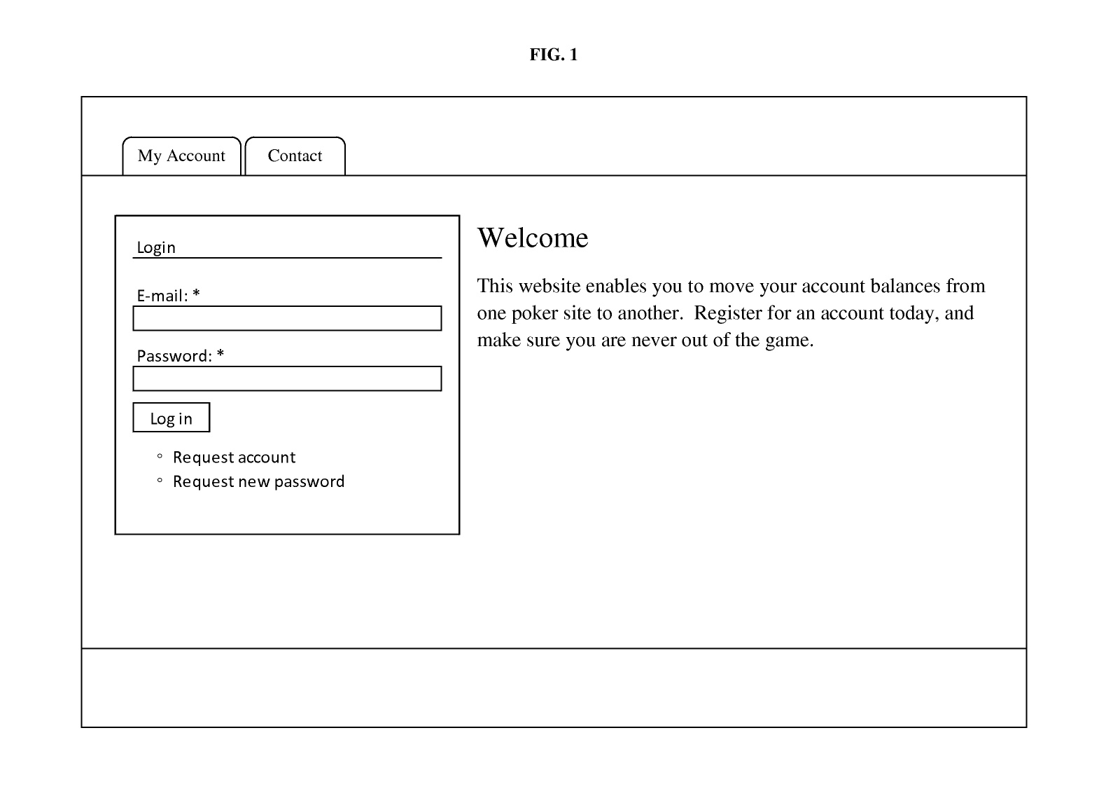

FIG. 2 is an example of a form used to begin a transfer between two of a user's poker gaming site accounts in one embodiment of the present invention.

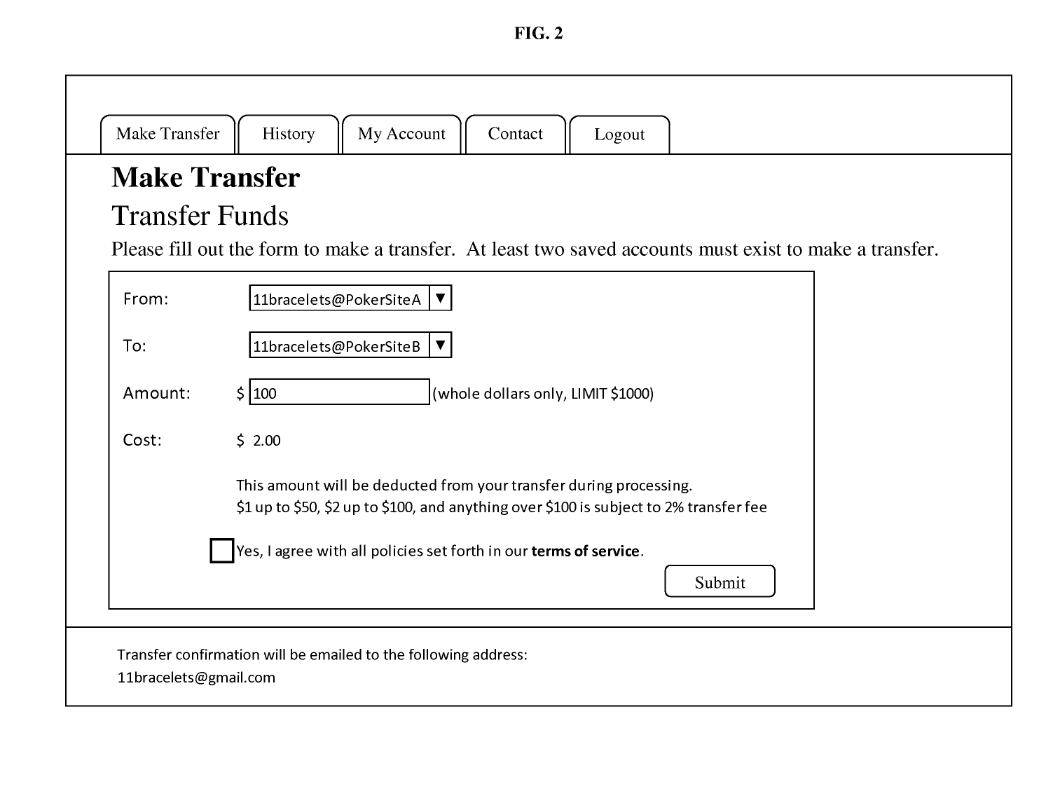

FIG. 3 is an example of a page on the disclosed website that allows a user to view a summary of their full personal transaction history between poker gaming site accounts facilitated by the disclosed website in one embodiment of the present invention.

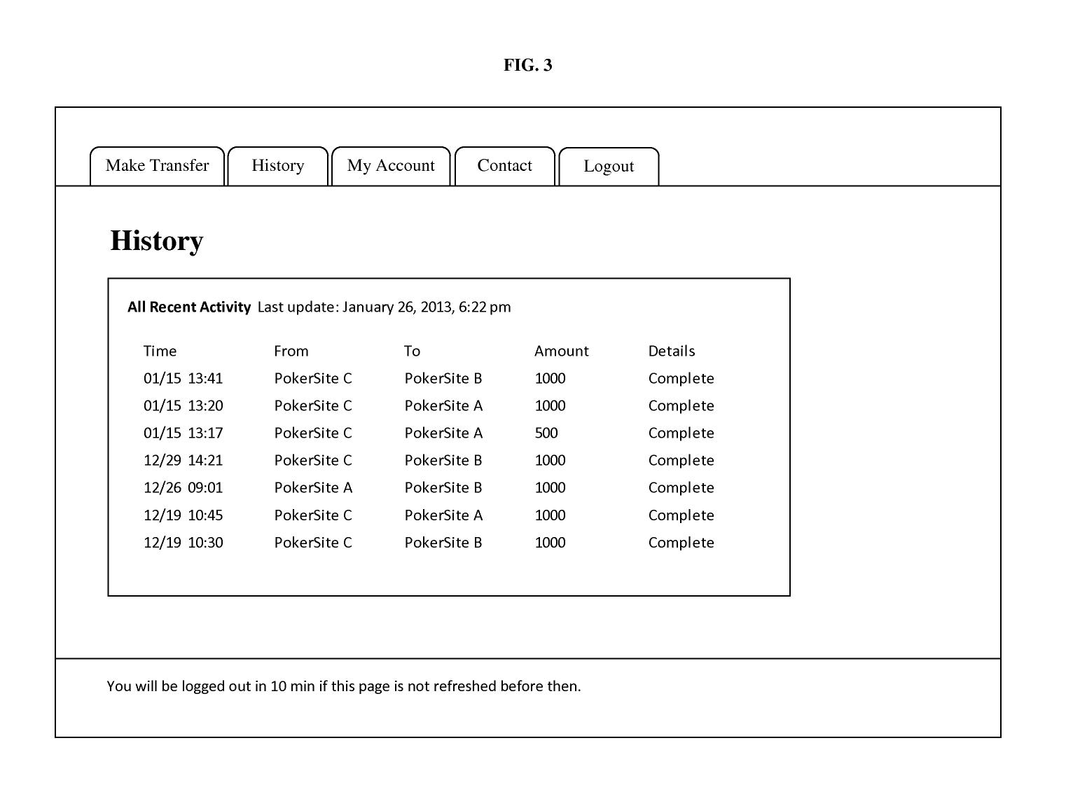

FIG. 4 is an example of a page on the disclosed website that allows a user to view the details associated with a specific transaction between poker gaming site accounts facilitated by the disclosed website in one embodiment of the present invention.

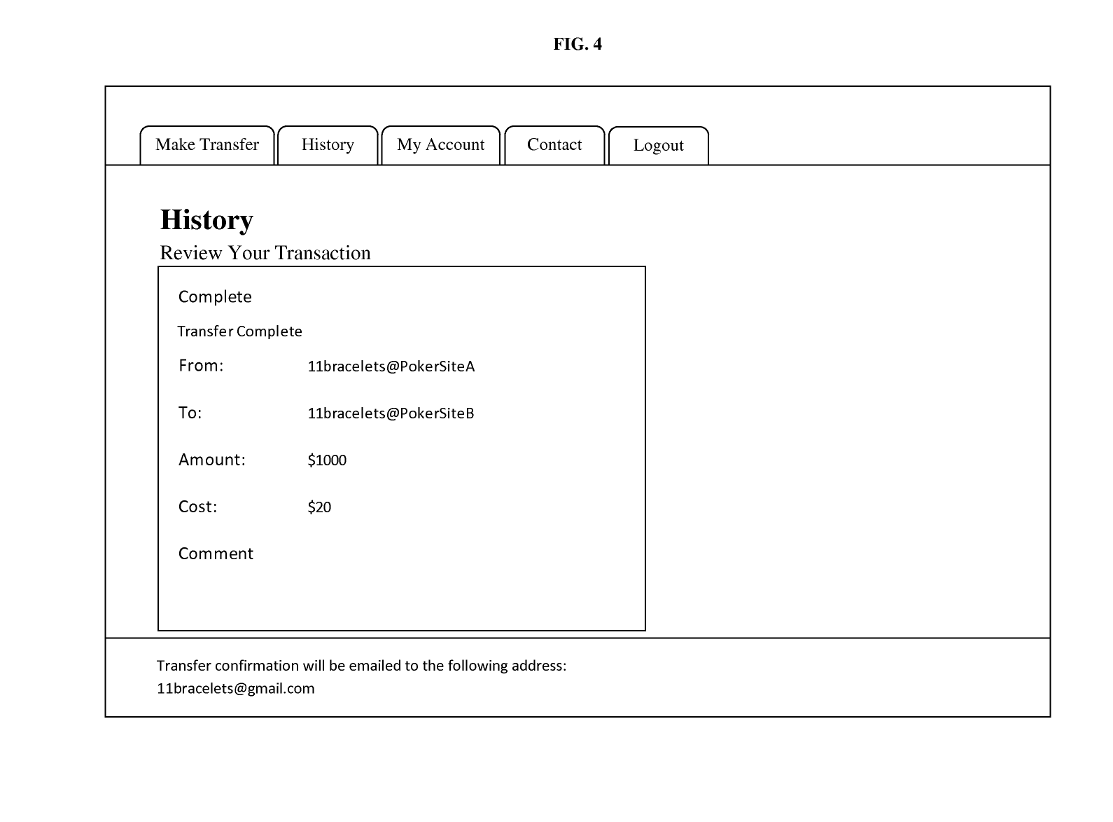

FIG. 5 is an example of a form used to update a user's account on the disclosed website in one embodiment of the present invention.

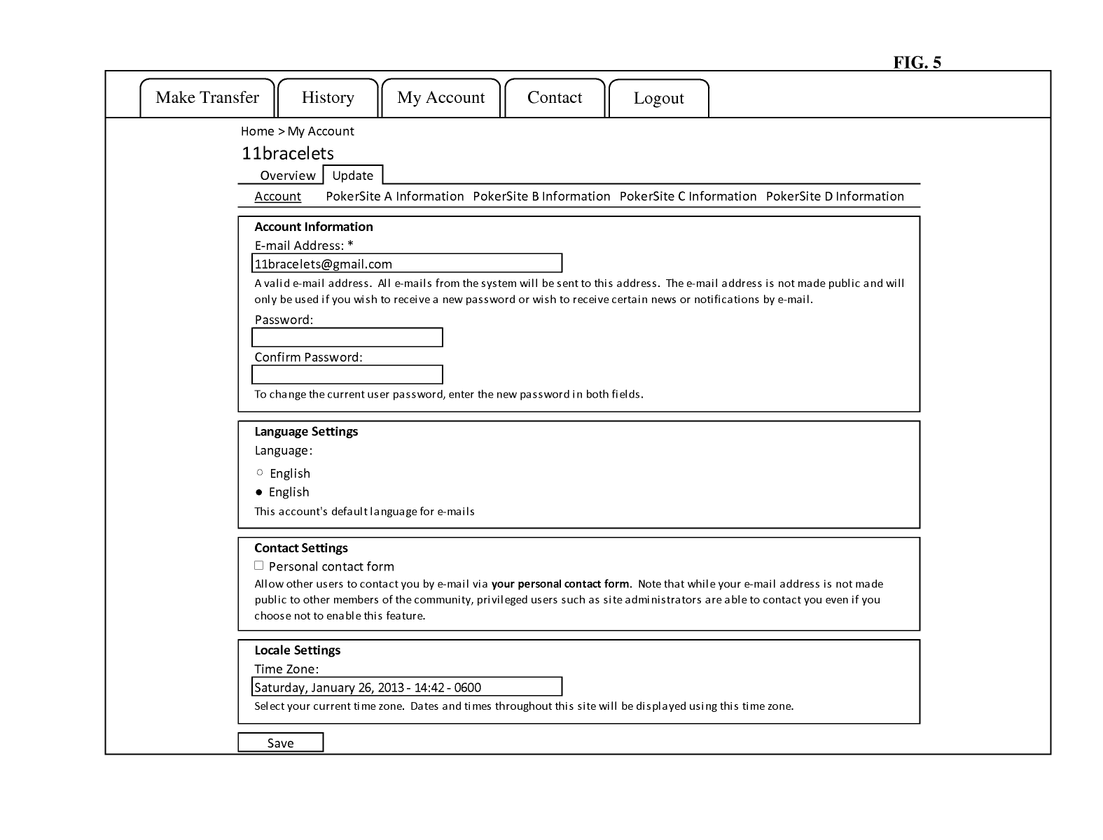

FIG. 6 is an example of a form used to update a user's account information associated with the user's account on a poker gaming site in one embodiment of the present invention.

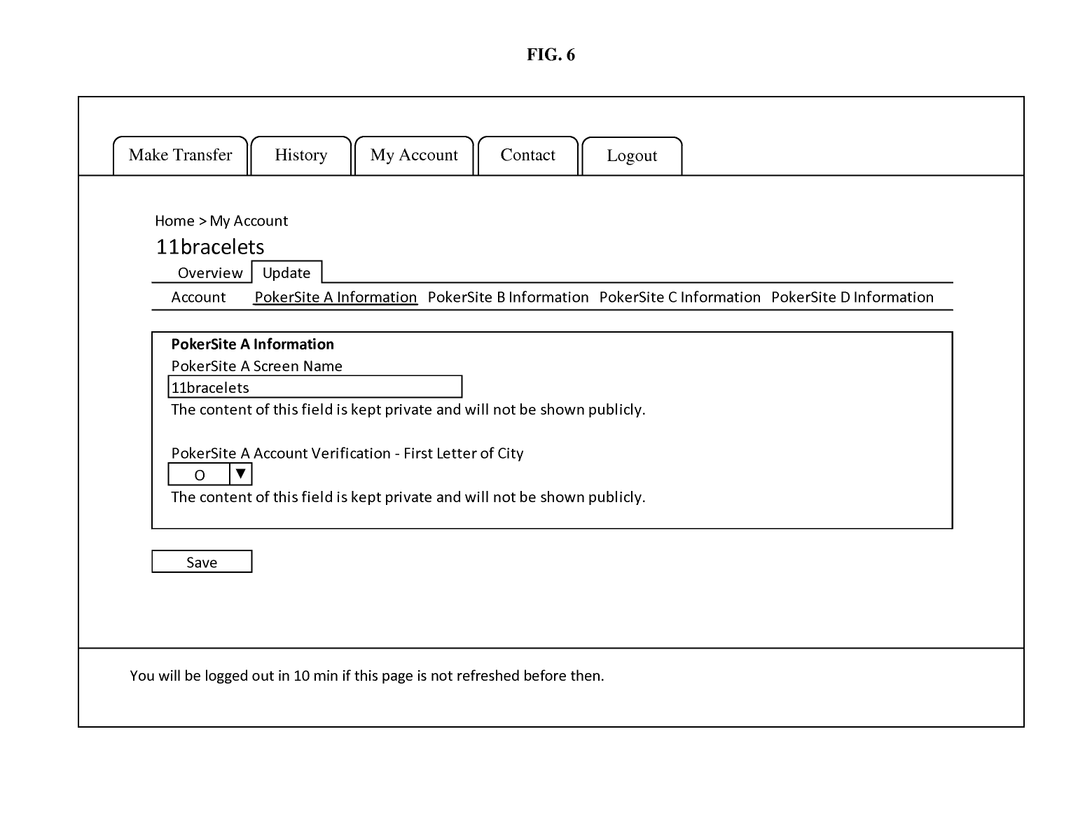

FIG. 7 is an example of a form used to contact the operator or administrator of the disclosed website in one embodiment of the present invention.

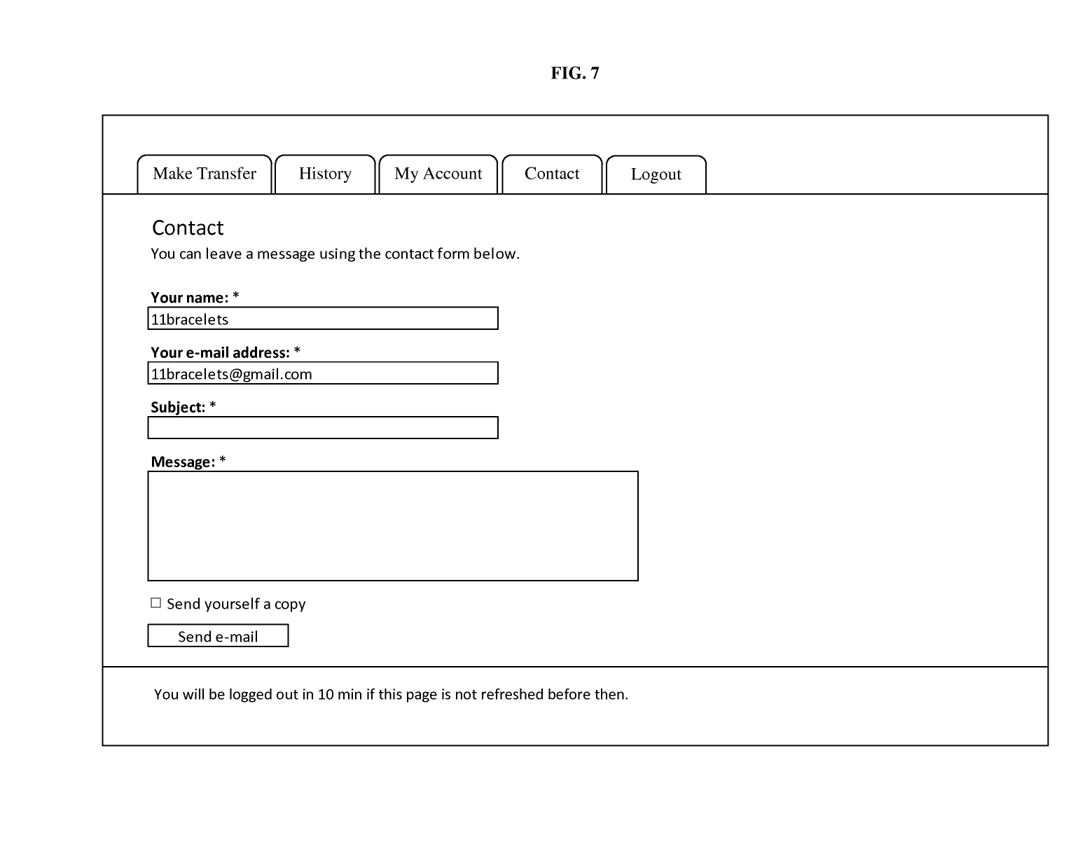

FIG. 8 is a diagram illustrating one example of how the disclosed website facilitates the transfer of funds between the accounts of a user on two separate poker gaming websites, in one embodiment of the present invention.

FIG. 9 is a schematic block diagram of an example computing system used to manage and transfer user account funds.

### DETAILED DESCRIPTION

Various embodiments will be described in detail with reference to the drawings. Reference to various embodiments does not limit the scope of the claims attached hereto. Additionally, any examples set forth in this specification are not intended to be limiting and merely set forth some of the many possible embodiments for the appended claims.

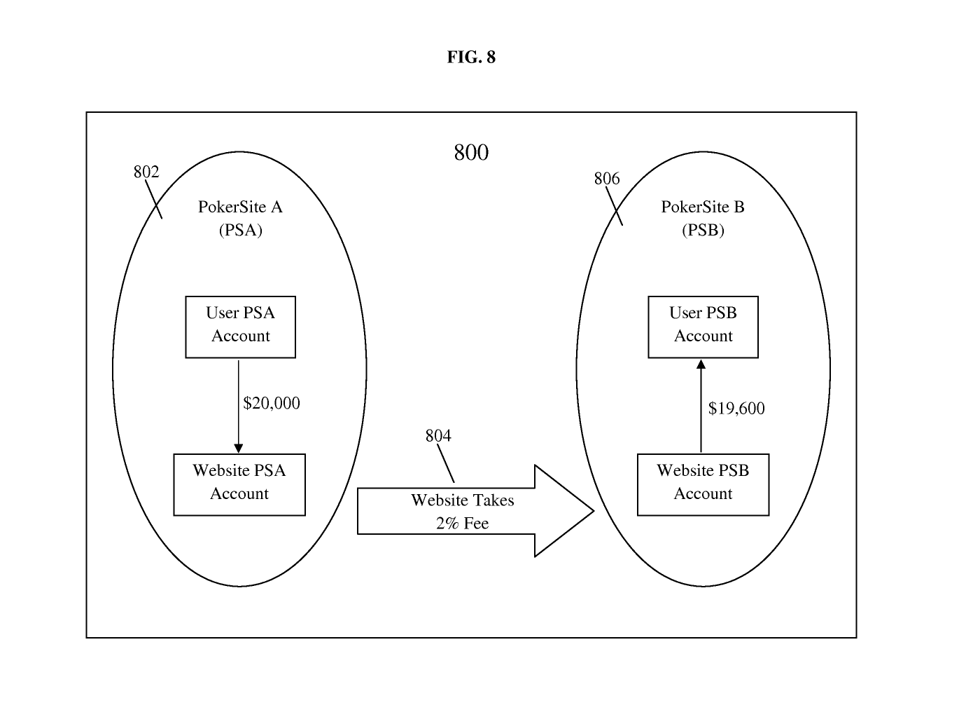

Referring to FIG. 8, using the present invention 800, a user could, for example, move $20,000 from poker site A to poker site B. In this example, a user would transfer $20,000 from their account on poker site A to the account held by the operator of the present invention on poker site A, 802. The operator would then transfer funds from their account on poker site B into the account of the user on poker site B, 806. The operator would have the ability to charge a predetermined fee for the transfer, 804, for example, 2% of the amount of funds transferred.

In another example, a tournament may be starting in 5 minutes on a poker site, and a user may not have sufficient funds in their account for that site, but may have $10,000 on another site for which the user holds an account. The user could use the present invention to transfer money from one account to the other for a fee, for example, 2%. The funds are transferred from the user's account into the account of the operator of the present invention, and in exchange funds are transferred from the operator's account to the user's account on a separate site where the user is low on funds. The system could also be designed such that the transfer happens automatically in the event an account has insufficient funds to continue play or is trending in a direction of insufficient funds.

The disclosed system provides an interface that shows the user what is happening at each step of the transfer process, so the user can be assured that they have not sent a random person $20,000 and that the funds will be transferred into the user's desired online poker account.

A user makes an account by going to the website of the present invention. The user creates an account on the website that stores their usernames associated with any of the online poker gaming sites for which they hold accounts. The user is then directed to a page that is labeled “Make a Transfer”. On this page the user can select which of their personal accounts they would like to transfer money FROM, and what account they would like to transfer money TO for a predetermined fee. Using a drop down menu for account FROM and account TO, the user can select which site accounts they would like to involve in the transfer and start the transfer process.

Next, a website operator receives the request for a transfer and is able to assist the user in the process and provide timely updates on the user's computer screen. For example, once the transfer request is received, the website operator notifies the user by means of a status icon on the user's computer (similar to when you download a program, the progress bar that tells you how far along you are) that will indicate to the user “Transfer Request Received” along with instructions on what to do next. After the money sent by the user is received in the website operator's account, the user is quickly notified by similar means as described above. The status icon updates in a timely manner on the user's computer to “Transfer Received”. The same process occurs when the website operator transfers funds into the user's account. A status icon will update to say “Transfer Sent”. Once the fund transfer is complete and the funds are in the user's account, the status icon will once again update to “Transfer Complete”.

In the preferred embodiment, the system operates by receiving a transfer request and working with the user in real time so the user is more comfortable about where their money is in the virtual space.

Users will use their poker site balances to send and receive money through the website of the present invention. If there is no money in the user's accounts, the website may also allow users to use their credit card or bank account to deposit money through the disclosed website and any other site supported by the website.

The website of the present invention employs various fraud prevention methods to help better verify accounts. The first method is to implement a service that allows a website operator to assign a specific token ID to a computer logging on to the service, for example, IEsnare. Major corporations such as MasterCard and Visa use this to prevent fraud as well. If a computer shows an ID that has been known to defraud an operator's business or another business, the website operator will know about it immediately and the transaction will not be allowed.

To verify accounts, the website will use a verification process similar to that used by PayPal. When a user makes an account on the website, an operator will send a random transfer for a small amount and ask the user to verify the amount that was sent. The operator might do this for every poker site used to transfer money. Once the transfer is verified by the user, it is safe to assume the user requesting transfers is the actual account holder.

The present invention also contemplates social media sharing of user stacks so friends will know where a user is playing and to join in possible games. Once a user has completed a transfer, the user will have the option to publish the new location of the user's currency to social media sites. This will inform the user's friends of where the user intends to play currently.

In an alternative embodiment, the system could provide a universal account or stack where the user funds only one account. The system would hold everything in the cloud and clears transactions out to poker sites and user, so a user's stack balance would apply to any site at which the user has an account.

Laws relating to online gaming and to money transfer vary by country and jurisdiction. As part of the above gaming-related funds transfer, the system could be designed to alert the user of the national laws related to the geographic location from the which the user is making a transfer and/or impose restrictions on transfer based on the laws of the user's geographic location. The location could be determined by any conventional means, including but not limited to IP address, user-identified location, GPS, Wi-Fi.

The disclosed system is not limited strictly to poker transactions. The system works to ease the uncertainty of where a user's money is in the virtual space. The user is notified at each step of each process as it happens. The system could aid in moving money from any site to any site in any environment, for example, commodities trading, online payments to auction sites such as eBay, PayPal, NetTeller, banks, and others.

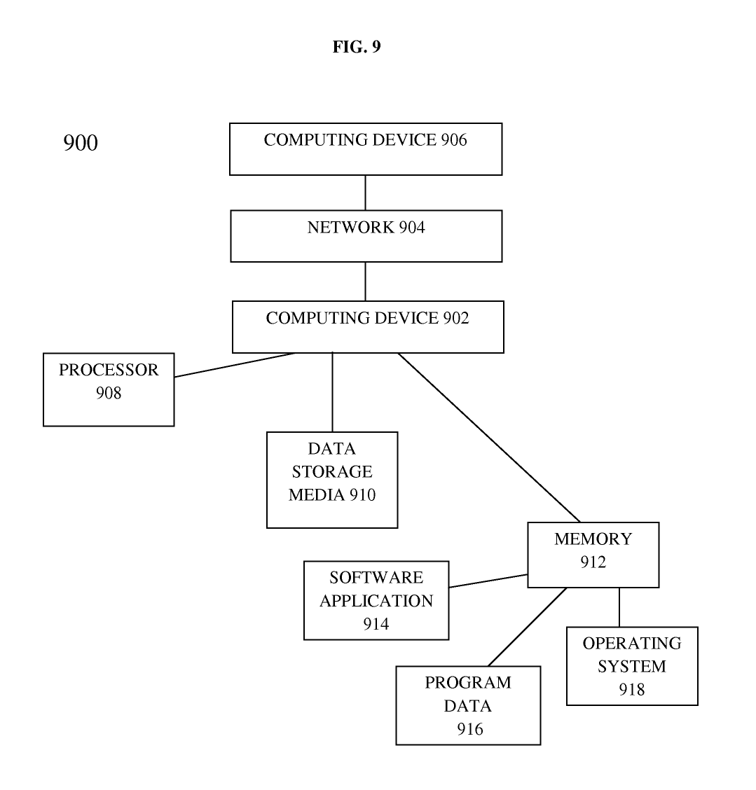

The disclosed invention involves technology that communicates with various online poker gaming or other websites, a website or application for facilitating the transfer of funds stored on the various gaming websites, and more, and uses a computing system. FIG. 9 is a schematic block diagram of an example computing system 900. The invention includes at least one computing device 902. In some embodiments the computing system further includes a communication network 904 and one or more additional computing devices 906 (such as a server).

Computing device 902 can be, for example, located in a place of business or can be a computing device located in a user's home. Computing device 902 can be a stand-alone computing device or a networked computing device that communicates with one or more other computing devices 906 across a network 904. The additional computing device(s) 906 can be, for example, located remotely from the first computing device 902, but configured for data communication with the first computing device 902 across a network 904.

In some examples, the computing devices 902 and 906 include at least one processor or processing unit 908 and system memory 912. Depending on the exact configuration and type of computing device, the system memory 912 may be volatile (such as RAM), non-volatile (such as ROM, flash memory, etc.) or some combination of the two. System memory 912 typically includes an operating system 918 suitable for controlling the operation of the computing device, such as the WINDOWS® operating systems from Microsoft Corporation of Redmond, Wash. or a server, such as Windows SharePoint Server, also from Microsoft Corporation. The system memory 912 may also include one or more software applications 914 and may include program data 916.

The computing device may have additional features or functionality. For example, the device may also include additional data storage devices 910 (removable and/or non-removable) such as, for example, magnetic disks, optical disks, or tape. Computer storage media 910 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices 902, 906 can be located in an establishment, such as a customer service center or other place of business. In other examples, the computing device can be a personal computing device that is networked to allow the user to access the present invention at a remote location, such as in a user's home or other location. In some embodiments, the computing device 902 is a smart phone, tablet or other mobile device. In some embodiments the invention is stored as data instructions for a smart phone application. A network 904 facilitates communication between the computing device 902 and one or more servers, such as an additional computing device 906, that host the web site of the invention. The network 904 may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 906 is a Web server. In this example, the first computing device 902 includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of the computing devices 902 and 906, the instructions cause the processor to perform one or more of the operations or methods disclosed herein. Examples of operations include the transfer of funds from one poker gaming site account to another poker gaming site account, the storage of account information for the operator of the present invention and multiple users, and other operations.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

1. A method of transferring currency from one server to another third-party server using a computing system comprising at least one server to host a currency transferring mechanism, at least one computing device communicably coupled to the at least one server through a communication network, and at least one display device, the method comprising:
providing a machine;
providing a non-transitory computer readable medium encoded with instructions and executed by a processor to perform the steps of:
causing at least one processor to execute a plurality of instructions stored in at least one memory device to operate with at least one input device to receive input regarding a first location of a user's currency;
after receiving the first location of a user's currency, causing at least one processor to execute a plurality of instructions stored in at least one memory device to operate with at least one input device to receive input regarding a second location of a user's currency;
causing the at least one processor to execute the plurality of instructions stored in the at least one memory device to operate with the at least one input device to receive a command to transfer the user's currency from the first location to the second location;
causing the at least one processor to execute the plurality of instructions stored in the at least one memory device to operate with the at least one display device to display an active graphic of the progress of the transfer of the user's currency from the first location to the second location; and
causing the at least one processor to execute the plurality of instructions stored in the at least one memory device to operate with the at least one display device to display a confirmation of the transfer of the user's currency from the first location to the second location when the transfer is complete.

2. The method of claim 1, wherein at least one computing device is one of a mobile device and a computer communicably coupled with the at least one server for data communication.

3. The method of claim 2, wherein at least one computing device is located at one of a gaming establishment and a remote location.

4. The method of claim 1, wherein the currency transferring mechanism is a web server that employs fraud prevention techniques.

5. The method of claim 1, further comprising causing the at least one processor to execute the plurality of instructions stored in the at least one memory device to operate with the at least one input device to receive a command to publish the second location of the user's currency to at least one social media website.

6. The method of claim 1, further comprising causing the at least one processor to transfer user currency from the first location to the second location while the user is playing an online casino game.

7. The method of claim 1 further comprising causing the at least one processor to cause such transfer to occur when user currency is below a pre-determined numerical threshold.
